(19) United States
(12) Patent Application Publication
(10) Pub. No.: US 2026/0226971 A1
(43) Pub. Date: Aug. 6, 2026

(54) WAVE GEAR DRIVE

(71) Applicant: Samsung Electro-Mechanics Co., Ltd., Suwon-si (KR)

(72) Inventors: Ju Ho KIM, Suwon-si (KR); Youngtae KIM, Suwon-si (KR); Min-Gu JO, Suwon-si (KR); Doohee LEE, Suwon-si (KR); Taeho YUN, Suwon-si (KR)

(73) Assignee: Samsung Electro-Mechanics Co., Ltd., Suwon-si (KR)

(21) Appl. No.: 19/285,831

(22) Filed: Jul. 30, 2025

(30) Foreign Application Priority Data
Feb. 6, 2025 (KR) 10-2025-0015183

(51) Int. Cl. F16H 49/00

(52) U.S. Cl. CPC F16H 49/001; F16H 2049/003

(57) ABSTRACT

A wave gear drive includes a wave generator including a shaft and a flexible bearing; a flex spline accommodating the wave generator; and a circular spline accommodating the flex spline. The flex spline includes a cylindrical portion into which the wave generator is disposed, a flange portion, and a curved portion connecting an end portion of the cylindrical portion to the flange portion. The curved portion includes regions with different radii of curvature.

### CROSS-REFERENCE TO RELATED APPLICATION

This application claims the benefit under 35 USC 119(a) of Korean Patent Application No. 10-2025-0015183 filed on Feb. 6, 2025, in the Korean Intellectual Property Office, the entire disclosure of which is incorporated herein by reference for all purposes.

### BACKGROUND

### 1. Field

The present disclosure relates to a wave gear drive.

### 2. Description of the Background

A wave gear drive is used in robot drivers and precision industrial machines due to its advantages of a simple structure, high reduction ratio, high rotation precision, light weight, and small size.

The wave gear drive is largely configured of a combination of three basic parts: a wave generator with a flexible ball bearing fitted on the outside of an elliptical cam; a flex spline, which is a metal elastic body consisting of a cylindrical portion and a flange portion with external gears formed on the outer surface of the cylindrical portion; and a circular spline, which is a rigid ring-shaped part.

When driving the wave gear drive, the flex spline is subjected to repeated, cyclical deformation and stress due to the rotation of the wave generator.

The wave generator is assembled to the flex spline, and the lower portion of the outer surface of the wave generator contacts the inner surface of the flex spline, but a gap is formed between the upper portion of the outer surface of the wave generator and the inner surface of the flex spline.

This gap accelerates the stress generation when driving the wave gear drive and causes stress concentration in the cylindrical and flange portions of the flex spline, which causes fatigue failure.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wave gear drive includes a wave generator including a shaft and a flexible bearing; a flex spline accommodating the wave generator; and a circular spline accommodating the flex spline. The flex spline includes a cylindrical portion into which the wave generator is disposed, a flange portion, and a curved portion connecting an end portion of the cylindrical portion to the flange portion. The curved portion includes regions with different radii of curvature.

The regions may include a first region adjacent to the flange portion and a second region adjacent to the cylindrical portion.

A radius of curvature of the first region may be smaller than a radius of curvature of the second region.

The first region may have a curved contour, and the second region may have an inclined contour.

The regions may further include a third region disposed between the first region and the second region.

A radius of curvature of the first region and a radius of curvature of the second region may be smaller than a radius of curvature of the third region.

The first region and the second region may have curved contours, and the third region may have a planar contour.

A radius of curvature of the first region may be smaller than a radius of curvature of the second region.

A depth of the curved portion may be ½ or less of a height of the curved portion.

A height of the curved portion may be 80% or less of a height of the cylindrical portion excluding an external gear disposed outside of the cylindrical portion.

In another general aspect, a wave gear drive includes a wave generator including a shaft and a flexible bearing; a flex spline accommodating the wave generator; and a circular spline accommodating the flex spline. The flex spline includes a cylindrical portion into which the wave generator is disposed, a flange portion, and a curved portion disposed between the flange portion and an end portion of the cylindrical portion. The curved portion has a concave contour around the end portion of the cylindrical portion.

A depth of the curved portion may be ½ or less of a height of the curved portion.

A height of the curved portion may be 80% or less of a height of the cylindrical portion excluding an external gear formed on the outside of the cylindrical portion.

Other features and aspects will be apparent from the following detailed description, the drawings, and the claims.

### BRIEF DESCRIPTION OF DRAWINGS

FIG. 1 illustrates a perspective view of a wave gear drive according to an embodiment.

FIG. 2 illustrates an exploded perspective view of a wave gear drive according to an embodiment.

FIG. 3 illustrates a cross-sectional view of a wave gear drive according to an embodiment.

FIG. 4 illustrates a cross-sectional view of a flex spline according to an embodiment.

FIG. 5 illustrates an enlarged view of portion A of FIG. 4.

FIG. 6 illustrates a cross-sectional view of a flex spline according to another embodiment.

FIG. 7 illustrates an enlarged view of portion B of FIG. 6.

FIG. 8 illustrates a cross-sectional view of a flex spline according to another embodiment.

FIG. 9 illustrates an enlarged view of portion C of FIG. 8.

FIG. 10 illustrates the shapes of flex splines of wave gear drives according to an embodiment and a comparative example.

FIG. 11 illustrates a gap between a flex spline and a wave generator.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

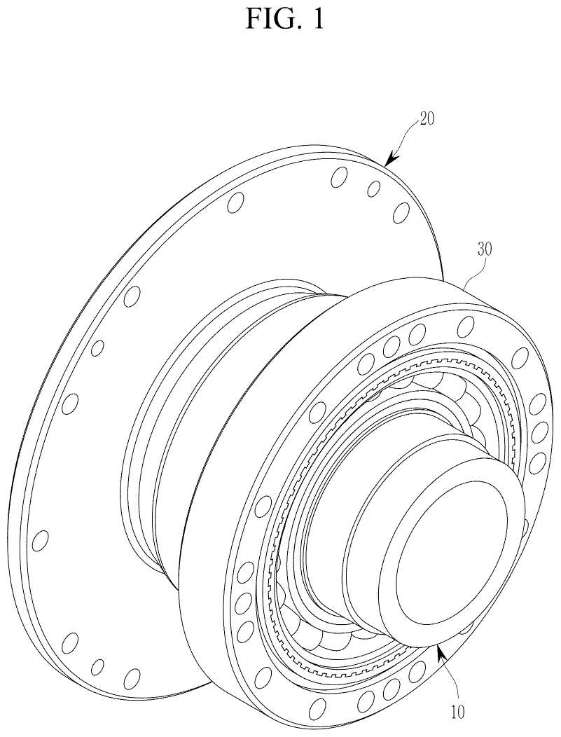

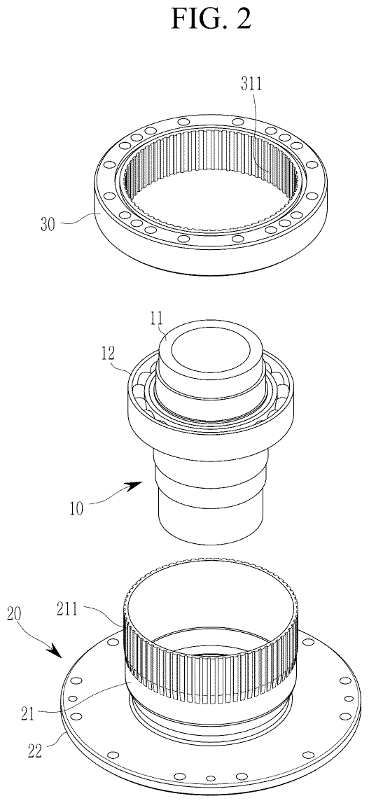

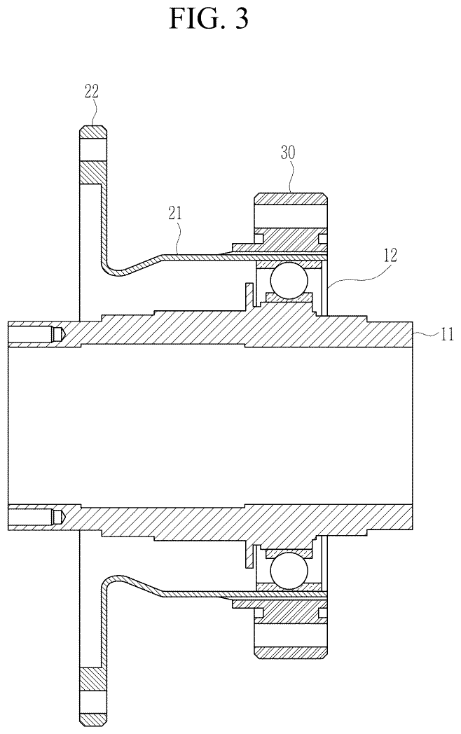

FIG. 1 illustrates a perspective view of a wave gear drive according to an embodiment. FIG. 2 illustrates an exploded perspective view of a wave gear drive according to an embodiment. FIG. 3 illustrates a cross-sectional view of a wave gear drive according to an embodiment.

Referring to FIG. 1 to FIG. 3, a wave gear drive according to an embodiment includes a wave generator 10, a flex spline 20, and a circular spline 30.

The wave generator 10 includes a shaft 11 having an elliptical shape and a flexible bearing 12. The shaft 11 may be manufactured in a cam shape, or a separate cam may be manufactured and fitted onto the shaft 11.

The shaft 11 is connected to the input shaft of a driving system (not shown) such as a motor and rotates, and the rotational power of the shaft 11 is transmitted to the flexible bearing 12 through the cam.

The flexible bearing 12 has a structure that allows its shape to be changeable. The flexible bearing 12 may be manufactured in a circular shape during manufacturing, but may be deformed according to the shape of the shaft 11 when coupled to the outside of the shaft 11. The flexible bearing 12 may be made of a metal material or engineering plastics.

The flex spline 20 is connected to interlock with the wave generator 10 with the flexible bearing 12 interposed therebetween, so that its shape is periodically deformed by the wave generated by the wave generator 10.

A detailed structure of the flex spline 20 of the present embodiment will be further described later.

The circular spline 30 has a ring shape made of a rigid body, and on the inside of the circular spline, an internal gear 311 is formed that is engaged with an external gear 211 of the flex spline 20. Typically, the number of internal gears 311 formed inside the circular spline 30 is greater than the number of external gears 211 formed in the flex spline 20.

When the wave generator 10 rotates by the rotational force transmitted from the input shaft of a driving system such as a motor by this structure, the flex spline 20 is deformed into an elliptical shape according to the shape of the wave generator 10. In this case, the external gear 211 of the flex spline 20 engages with the internal gear 311 of the circular spline 30 at both ends of the elliptical long axis.

When the wave generator 10 rotates around the rotation axis, the engagement position of the external gear 211 and the internal gear 311 rotates in the circumferential direction. By this rotation, relative rotation occurs between the external gear and the internal gear 311 according to the difference in the number of teeth between the external gear 211 and the internal gear 311.

For example, if the internal gear 311 is fixed and the wave generator 10 is used as a high-speed rotation input element, the external gear 211 becomes a reduced rotation output element, and a reduced rotation output is output according to the difference in the number of teeth of the two gears.

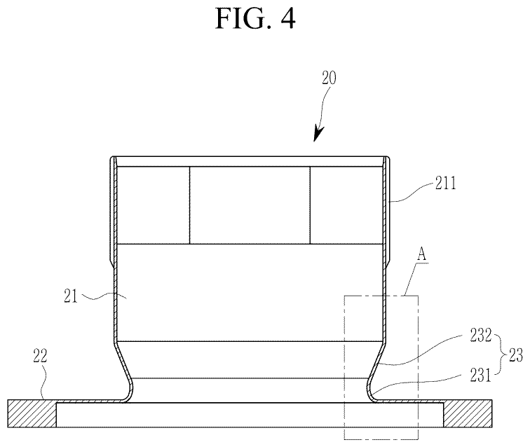

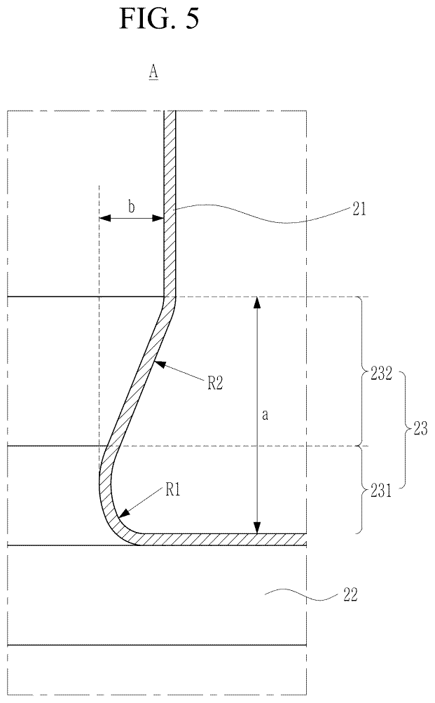

Hereinafter, the flex spline 20 of the wave gear drive according to the present embodiment will be described in more detail with reference to FIG. 4 and FIG. 5.

FIG. 4 illustrates a cross-sectional view of a flex spline according to an embodiment, and FIG. 5 illustrates an enlarged view of portion A of FIG. 4.

Referring to FIG. 4 and FIG. 5, the flex spline 20 of the wave gear drive according to the present embodiment includes a cylindrical portion 21 and a flange portion 22. The flex spline 20 has an overall silk hat shape.

The cylindrical portion 21 has a cylindrical shape with one end open and the other end connected to the flange portion 22. The wave generator 10 is coupled to the inside of the cylindrical portion 21. The cylindrical portion 21 has the external gear 211 formed on the outside thereof, and the external gear 211 is disposed to face the internal gear 311 of the circular spline 30. The flange portion 22 is a portion that extends in a radial direction, which is a direction perpendicular to the center line of the cylinder portion 21.

A curved portion 23 having a concave shape is formed at a portion where the cylindrical portion 21 and the flange portion 22 meet. That is, the curved portion 23 is formed inward from the outermost surface of the cylindrical portion 21 around the end portion of the cylindrical portion 21 connected to the flange portion 22. The curved portion 23 is formed below the external gear 211 of the flex spline 20.

The curved portion 23 may have a predetermined radius of curvature, and in this case, each region thereof may have a different radius of curvature. The curved portion 23 may include a first region 231 adjacent to the flange portion 22 and a second region 232 adjacent to the cylindrical portion 21. The radii of curvature of the first region 231 and the second region 232 may be different from each other. For example, the radius of curvature of the first region 231 may be smaller than the radius of curvature of the second region 232.

The curved portion 23 may have the first region 231 that has a curved contour or is a curved surface having an arc, and the second region 232 which is formed as an inclined surface that is inclined inward from the outermost surface of the cylindrical portion 21. In this case, the second region 232 may have a planar shape or a curved surface shape that is more smoothly rounded than the first region 231.

A height (a) of the curved portion 23 may be 80% or less of a height of the cylindrical portion 21 excluding the external gear 211. The external gear 211 is formed on the outer surface of the cylindrical portion 21, and the internal gear 311 of the circular spline 30 is engaged with the external gear 211. Therefore, in order to maintain a gear processing area and ensure assembly with the circular spline 30, the height of the curved portion 23 is about 80% or less of the height excluding the external gear 211 of the cylindrical portion 21.

The curved portion 23 may have a depth (b) equal to or less than ½ of the height (a). Here, the depth (b) of the curved portion 23 is the length from the outermost surface of the cylindrical portion 21 to the innermost surface of the curved portion 23, and the height (a) thereof is the length from the point where the curved portion 23 meets the flange portion 22 to the point where the curved portion 23 meets the cylindrical portion 21. The height (a) of the curved portion 23 may be regarded as the maximum diameter when the curved portion 23 is made into a semicircle, and therefore, it may be desirable that the depth (b) of the curved portion 23 be less than half of the height (a) of the curved portion 23, which is the radius of the semicircle.

According to the present embodiment, when the wave generator 10 is assembled to the flex spline 20, a gap generated between the upper outer surface of the wave generator 10 and the inner surface of the flex spline 20 may be reduced by the curved portion 23. In addition, the curved portion 23 may alleviate the stress concentrated at the point where the cylindrical portion 21 and the flange portion 22 meet when the cylindrical portion 21 is periodically elastically deformed.

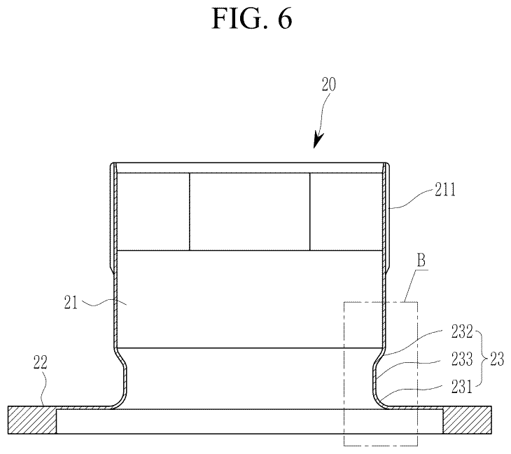

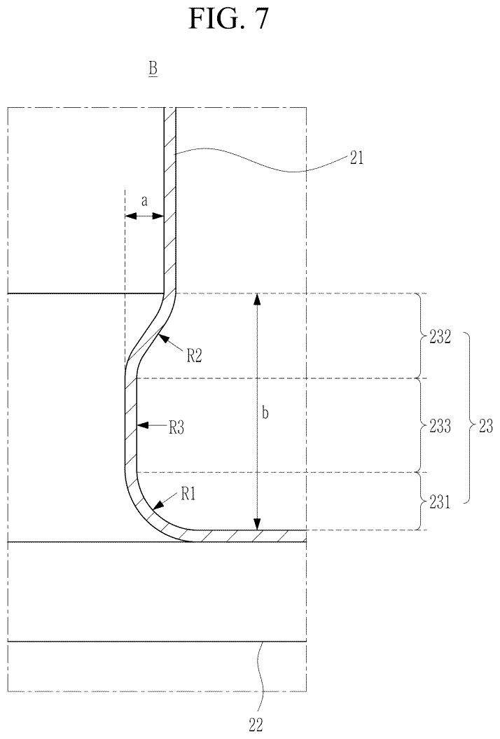

Hereinafter, a flex spline of a wave gear drive according to another embodiment will be described in more detail with reference to FIG. 6 and FIG. 7.

FIG. 6 illustrates a cross-sectional view of a flex spline according to another embodiment, and FIG. 7 illustrates an enlarged view of portion B of FIG. 6.

Referring to FIG. 6 and FIG. 7, the flex spline of the wave gear drive according to the present embodiment has substantially the same configuration as the embodiment described with reference to FIG. 1 to FIG. 5. Hereinafter, configurations that are different from the embodiment described with reference to FIG. 1 to FIG. 5 will be described. The same reference numerals will be used for the same configurations, and configurations that are not described separately may be configured in the same manner as the embodiment illustrated in FIG. 1 to FIG. 5.

Referring to FIGS. 6 and 7, the flex spline 20 of the wave gear drive according to the present embodiment includes a cylindrical portion 21 and a flange portion 22, and a curved portion 23 is formed at a portion where the cylindrical portion 21 and the flange portion 22 meet.

The curved portion 23 may include a first region 231 adjacent to the flange portion 22, a second region 232 adjacent to the cylindrical portion 21, and a third region 233 positioned between the first region 231 and the second region 232.

The curved portion 23 may have a predetermined radius of curvature, and in this case, each region thereof may have a different radius of curvature. For example, a radius of curvature of the first region 231 and a radius of curvature of the second region 232 may be smaller than a radius of curvature of the third region 233. In this case, the radius of curvature of the first region 231 may be equal to or smaller than the radius of curvature of the second region 232.

The curved portion 23 may have a curved shape in which the first region 231 and the second region 232 have an arc, and the third region 233 may have a planar shape. In this case, the curved surface of the first region 231 may have a slightly more rounded curved surface shape than the curved surface of the second region 232, that is, the radius of curvature of the first region 231 may be smaller than the radius of curvature of the second region 232.

The height (a) of the curved portion 23 may be 80% or less of the height excluding the external gear 211 of the cylindrical portion 21, and the depth (b) may be formed to be ½ or less of the height (a). Here, the depth (b) of the curved portion 23 is the length from the outermost surface of the cylindrical portion 21 to the innermost surface of the curved portion 23. That is, the surface of the third region 233, and the height (a) thereof is the length from the point where the curved portion 23 meets the flange portion 22 to the point where the curved portion 23 meets the cylindrical portion 21. The height (a) of the curved portion 23 may be regarded as the maximum diameter when the curved portion 23 is made into a semicircle. Therefore, it may be desirable that the depth (b) of the curved portion 23 be less than half of the height (a) of the curved portion 23, which is the radius of the semicircle.

According to the present embodiment, when the wave generator 10 is assembled to the flex spline 20, a gap generated between the upper outer surface of the wave generator 10 and the inner surface of the flex spline 20 may be reduced by the curved portion 23. In addition, the curved portion 23 may alleviate the stress concentrated at the point where the cylindrical portion 21 and the flange portion 22 meet when the cylindrical portion 21 is periodically elastically deformed.

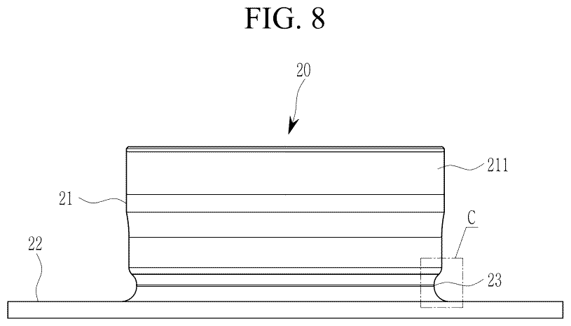

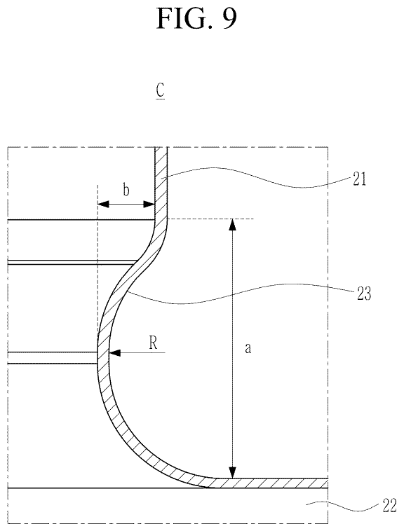

Hereinafter, a flex spline of a wave gear drive according to another embodiment will be described in more detail with reference to FIG. 8 and FIG. 9.

FIG. 8 illustrates a cross-sectional view of a flex spline according to another embodiment, and FIG. 9 illustrates an enlarged view of portion C of FIG. 8.

Referring to FIG. 8 and FIG. 9, the flex spline of the wave gear drive according to the present embodiment has substantially the same configuration as the embodiment described with reference to FIG. 1 to FIG. 5. Hereinafter, configurations that are different from the embodiment described with reference to FIG. 1 to FIG. 5 will be described. The same reference numerals will be used for the same configurations, and configurations that are not described separately may be configured in the same manner as the embodiment illustrated in FIG. 1 to FIG. 5.

Referring to FIGS. 8 and 9, the flex spline 20 of the wave gear drive according to the present embodiment includes a cylindrical portion 21 and a flange portion 22. A curved portion 23 is formed at a portion where the cylindrical portion 21 and the flange portion 22 meet. That is, the curved portion 23 is concavely formed inward from the outermost surface of the cylindrical portion 21 around the end portion of the cylindrical portion 21 connected to the flange portion 22. The curved portion 23 may have a predetermined radius of curvature (R) and may have a curved shape having an arc.

The height (a) of the curved portion 23 may be 80% or less of the height excluding the external gear 211 of the cylindrical portion 21, and the depth (b) may be formed to be ½ or less of the height (a). Here, the depth (b) of the curved portion 23 is the length from the outermost surface of the cylindrical portion 21 to the innermost surface of the curved portion 23. The height (a) of the curved portion 23 is the length from the point where the curved portion 23 meets the flange portion 22 to the point where the curved portion 23 meets the cylindrical portion 21. The height (a) of the curved portion 23 may be regarded as the maximum diameter when the curved portion 23 is made into a semicircle. Therefore, it may be desirable that the depth (b) of the curved portion 23 be less than half of the height (a) of the curved portion 23, which is the radius of the semicircle. In the present embodiment, the depth (b) of the curved portion 23 may be equal to the curvature radius (R) of the curved portion 23.

According to the present embodiment, when the wave generator 10 is assembled to the flex spline 20, a gap generated between the upper outer surface of the wave generator 10 and the inner surface of the flex spline 20 may be reduced by the curved portion 23. In addition, the curved portion 23 may alleviate the stress concentrated at the point where the cylindrical portion 21 and the flange portion 22 meet when the cylindrical portion 21 is periodically elastically deformed.

### Experimental Example

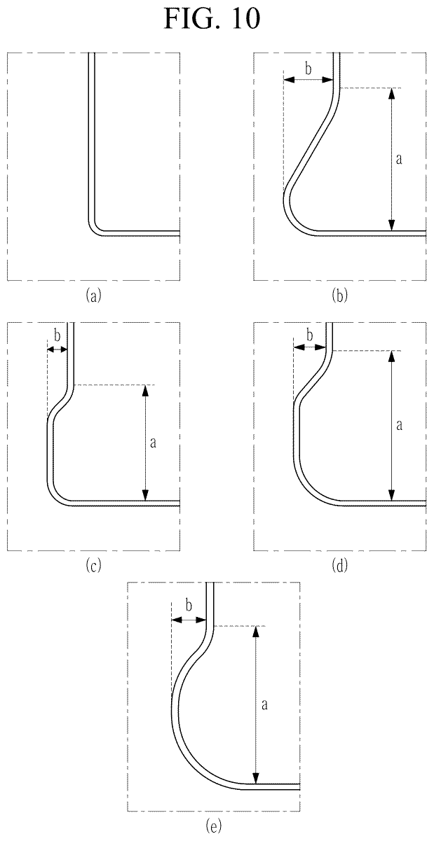

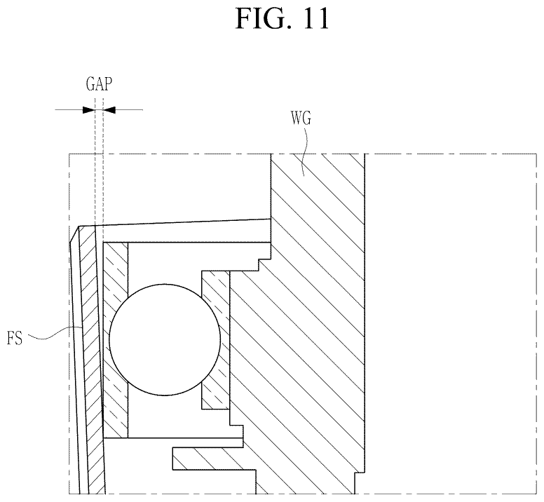

Hereinafter, the assemblability and stress concentration effects of the wave gear drive according to examples and a comparative example will be described with reference to FIG. 10, FIG. 11, and Table 1.

FIG. 10 illustrates the shapes of flex splines of wave gear drives according to an embodiment and a comparative example. FIG. 11 illustrates a gap between a flex spline and a wave generator. Table 1 shows the results of a finite element method (FEM) simulation of the wave gear drives according to examples and a comparative example.

TABLE 1

| | Height of | Depth of | Gap | Maximum |
|---|---|---|---|---|
| | curved portion | curved portion | [g, | stress |
| Classification | [a, mm] | [b, mm] | um] | [Mpa] |
| Comparative | — | — | 93 | 173 |
| example | | | | |
| Example 1 | 7.0 | 2.5 | 88 | 126 |
| Example 2 | 5.0 | 1.0 | 96 | 148 |
| Example 3 | 7.0 | 1.5 | 98 | 148 |
| Example 4 | 7.0 | 1.5 | 98 | 156 |

Referring to FIG. 10, (a) shows the shape of the flex spline of the wave gear drive according to the comparative example, (b) shows the shape of the flex spline of the wave gear drive according to Example 1, (c) shows the shape of the flex spline of the wave gear drive according to Example 2, (d) shows the shape of the flex spline of the wave gear drive according to Example 3, and (e) shows the shape of the flex spline of the wave gear drive according to Example 4.

The comparative example is a case in which no curved portion is formed between the cylindrical portion and the flange portion of the flex spline. Example 1 is a case in which the curved portion includes a first region adjacent to the flange portion and a second region adjacent to the cylindrical portion. The first region is a curved surface shape having an arc and the second region is formed as an inclined surface. In addition, Example 2 and Example 3 are cases in which the curved portion is formed of three regions and includes a third region having a planar shape between the first and second regions which are curved surfaces. Example 2 and Example 3 are cases in which there is a difference in the depth and height of the curved portion. Example 4 is a case in which the curved portion is formed as a curved shape having a predetermined radius of curvature.

Table 1 shows the results using Simulia ABAQUS as the FEM simulation software (SW). Referring to Table 1, Example 1 had a depth of the curved portion of 2.5 mm, which was less than half the height (7.0 mm) of the curved portion, a gap (g) between the flex spline and the wave generator of 88 μm, and a maximum stress of 126 MPa.

Referring to FIG. 11, the gap (g) between the flex spline (FS) and the wave generator (WG) represents the gap between the upper outer surface of the wave generator (WG) and the inner surface of the flex spline (FS).

Example 2 had a depth of the curved portion of 1 mm, which was less than half the height (5.0 mm) of the curved portion, the gap (g) between the flex spline and the wave generator of 96 μm, and a maximum stress of 148 MPa.

Example 3 had a depth of the curved portion of 1.5 mm, which was less than half the height (7.0 mm) of the curved portion, the gap (g) between the flex spline and the wave generator of 98 μm, and a maximum stress of 148 MPa.

Example 4 had a depth of the curved portion of 1.5 mm, which was less than half the height (7.0 mm) of the curved portion, the gap (g) between the flex spline and the wave generator of 98 μm, and a maximum stress of 156 MPa.

In the comparative example, the gap (g) between the flex spline and the wave generator was 93 μm, and the maximum stress was 173 MPa.

In the comparative example, the maximum stress was the highest, and in the case of Example 1, the gap between the flex spline and the wave generator was the lowest and the maximum stress was also the lowest. Therefore, it can be seen that in the case of Example 1, the gap between the flex spline and the wave generator may be minimized, and the stress concentration at the portion where the cylindrical portion and the flange portion of the flex spline meet may be most effectively alleviated.

In the case of Example 2 to Example 4, the gap between the flex spline and the wave generator was slightly higher than that of the comparative example, but the maximum stress was much lower than that of the comparative example. Therefore, it can be seen that in Example 2 to Example 4, the stress concentration at the portion where the cylindrical portion and the flange portion of the flex spline meet is alleviated.

In summary of Example 1 to Example 4, it can be seen that it may be desirable that the shape of the curved portion has a concave contour with different radii of curvature for respective regions, and that the depth of the curved portion is ½ or less of the height of the curved portion.

One or more embodiments attempt to provide a wave gear drive that may minimize a gap occurring between an outer upper surface of a wave generator and an inner surface of a flex spline and may alleviate stress concentrated on a cylindrical portion and a flange portion of the flex spline.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wave gear drive, comprising:
a wave generator comprising a shaft and a flexible bearing;
a flex spline accommodating the wave generator; and
a circular spline accommodating the flex spline,
wherein the flex spline comprises a cylindrical portion into which the wave generator is disposed, a flange portion, and a curved portion connecting an end portion of the cylindrical portion to the flange portion, and
wherein the curved portion comprises regions with different radii of curvature.

2. The wave gear drive of claim 1, wherein
the regions comprise a first region adjacent to the flange portion and a second region adjacent to the cylindrical portion.

3. The wave gear drive of claim 2, wherein
a radius of curvature of the first region is smaller than a radius of curvature of the second region.

4. The wave gear drive of claim 2, wherein
the first region has a curved contour, and the second region has an inclined contour.

5. The wave gear drive of claim 2, wherein
the regions further comprise a third region disposed between the first region and the second region.

6. The wave gear drive of claim 5, wherein
a radius of curvature of the first region and a radius of curvature of the second region are smaller than a radius of curvature of the third region.

7. The wave gear drive of claim 5, wherein
the first region and the second region have curved contours, and the third region has a planar contour.

8. The wave gear drive of claim 7, wherein
a radius of curvature of the first region is smaller than a radius of curvature of the second region.

9. The wave gear drive of claim 1, wherein
a depth of the curved portion is ½ or less of a height of the curved portion.

10. The wave gear drive of claim 1, wherein
a height of the curved portion is 80% or less of a height of the cylindrical portion excluding an external gear disposed outside of the cylindrical portion.

11. A wave gear drive, comprising:
a wave generator comprising a shaft and a flexible bearing;
a flex spline accommodating the wave generator; and
a circular spline accommodating the flex spline,
wherein the flex spline comprises a cylindrical portion into which the wave generator is disposed, a flange portion, and a curved portion disposed between the flange portion and an end portion of the cylindrical portion, and
wherein the curved portion has a concave contour around the end portion of the cylindrical portion.

12. The wave gear drive of claim 11, wherein
a depth of the curved portion is ½ or less of a height of the curved portion.

13. The wave gear drive of claim 11, wherein
a height of the curved portion is 80% or less of a height of the cylindrical portion excluding an external gear formed on the outside of the cylindrical portion.
